(19) United States
(12) Patent Application Publication
(10) Pub. No.: US 2025/0219503 A1
(43) Pub. Date: Jul. 3, 2025

(54) MOTOR

(71) Applicant: EXEDY Corporation, Osaka (JP)

(72) Inventors: Shu Ohiwa, Osaka (JP); Koki OHNO, Osaka (JP); Kenji KITADA, Osaka (JP); Hitoshi KATSURA, Osaka (JP); Kengo MIYAKE, Osaka (JP)

(21) Appl. No.: 18/965,051

(22) Filed: Dec. 2, 2024

(30) Foreign Application Priority Data
Dec. 28, 2023 (JP) 2023-223488

(51) Int. Cl. H02K 7/04; H02K 21/22

(52) U.S. Cl. CPC H02K 7/04; H02K 21/22

(57) ABSTRACT

The disclosed motor is configured to prevent a balance weight from coming off from a rotor frame. The motor includes a rotor frame, a rotor, and a stator. The rotor frame includes a plurality of ribs. Each of the plurality of ribs includes one or more accommodation holes. The ribs are disposed away from each other at intervals in a circumferential direction. Each of the ribs each extends in a radial direction. The rotor is supported by the rotor frame. The rotor has an annular shape. The stator is disposed radially inside the rotor.

### CROSS-REFERENCE TO RELATED APPLICATIONS

This application is based on and claims the priority benefit of Japanese application 2023-223488 filed on Dec. 28, 2023, the contents of which are incorporated herein by reference.

### TECHNICAL FIELD

The claimed invention relates to a motor.

### BACKGROUND

Drones have become common in recent years. In general, a drone includes a body, a plurality of arms extending from the body in a radial shape, and a plurality of motors attached to the distal ends of the arms, respectively. The motors rotate propellers, respectively. Each motor includes a rotor frame supporting a rotor; the rotor and the rotor frame are rotated. See, for example, United States Patent Application Publication No. 2019/0181701.

The rotor and the rotor frame could cause imbalance depending on component dimensional accuracy or assemblage accuracy. Therefore, a weight for balance adjustment (balance weight) is bonded to the rotor frame. However, there is a drawback in that when the rotor and the rotor frame are rotated, the balance weight undesirably comes off from the rotor frame by centrifugal forces generated by the rotation.

### SUMMARY OF THE CLAIMED INVENTION

In view of the above, it is an object of the claimed invention to prevent the balance weight from coming off from the rotor frame. A motor according to a first aspect includes a rotor frame, a rotor, and a stator. The rotor frame includes a plurality of ribs. Each of the plurality of ribs includes an accommodation hole. The plurality of ribs are disposed away from each other at intervals in a circumferential direction. The plurality of ribs each extend in a radial direction. The rotor is supported by the rotor frame. The rotor has an annular shape. The stator is disposed radially inside the rotor.

According to this configuration, each of the plurality of ribs is provided with the accommodation hole; hence, it is made possible to rigidly attach the balance weight to the rotor frame by disposing the balance weight in the accommodation hole. As a result, it is made possible to prevent the balance weight from coming off from the rotor frame.

A motor according to a second aspect relates to the motor according to the first aspect and further includes at least one balance weight. The at least one balance weight is disposed in at least one of the accommodation holes.

A motor according to a third aspect relates to the motor according to the first or second aspect and is configured as follows. Each of the plurality of ribs includes a plurality of the accommodation holes disposed away from each other at intervals in the radial direction.

A motor according to a fourth aspect relates to the motor according to the third aspect and is configured as follows. The plurality of accommodation holes are different in opening area from each other. When described in detail, the plurality of accommodation holes included in each rib are different in opening area from each other.

A motor according to a fifth aspect relates to the motor according to the third or fourth aspect and is configured as follows. The plurality of accommodation holes are aligned radially outward in a descending order of opening area. When described in detail, the plurality of accommodation holes, included in each rib, are aligned radially outward in the descending order of opening area.

A motor according to a sixth aspect relates to the motor according to the third or fourth aspect and is configured as follows. The plurality of accommodation holes are aligned radially outward in an ascending order of opening area. When described in detail, the plurality of accommodation holes, included in each rib, are aligned radially outward in the ascending order of opening area.

A motor according to a seventh aspect relates to the motor according to any of the third to sixth aspects and is configured as follows. The plurality of accommodation holes are different in depth from each other. When described in detail, the plurality of accommodation holes, included in each rib, are different in depth from each other.

A motor according to an eighth aspect relates to the motor according to any of the third to seventh aspects and is configured as follows. The plurality of accommodation holes are aligned radially outward in a descending order of depth. When described in detail, the plurality of accommodation holes, included in each rib, are aligned radially outward in the descending order of depth.

A motor according to a ninth aspect relates to the motor according to any of the third to seventh aspects and is configured as follows. The plurality of accommodation holes are aligned radially outward in an ascending order of depth. When described in detail, the plurality of accommodation holes, included in each rib, are aligned radially outward in the ascending order of depth.

A motor according to a tenth aspect relates to the motor according to the first or second aspect and is configured as follows. Each of the accommodation holes is made in shape of an elongated hole extending in the radial direction.

A motor according to an eleventh aspect relates to the motor according to the tenth aspect and is configured as follows. Each of the accommodation holes is gradually reduced in width radially outward.

A motor according to a twelfth aspect relates to the motor according to the tenth aspect and is configured as follows. Each of the accommodation holes is gradually increased in width radially outward.

A motor according to a thirteenth aspect relates to the motor according to any of the tenth to twelfth aspects and is configured as follows. Each of the accommodation holes is gradually reduced in depth radially outward.

A motor according to a fourteenth aspect relates to the motor according to any of the tenth to twelfth aspects and is configured as follows. Each of the accommodation holes is gradually increased in depth radially outward.

A motor according to a fifteenth aspect relates to the motor according to any of the first to fourteenth aspects and is configured as follows. The rotor frame includes a top plate portion and a slant portion. The top plate portion has a disc shape. The slant portion is disposed radially outside the top plate portion. The slant portion has an annular shape. The accommodation holes are disposed radially inside the slant portion.

Overall, according to the claimed invention, it is made possible to prevent a balance weight from coming off from a rotor frame.

### BRIEF DESCRIPTION OF THE DRAWINGS

FIG. 1 is a cross-sectional view of a motor in accordance with the claimed invention.

FIG. 2 is a perspective view of a rotor frame in accordance with the claimed invention.

FIG. 3 is a perspective view of a rotor frame according to an example in a modification.

FIG. 4 is an enlarged perspective view of a portion of a rotor frame according to another example in the modification.

FIG. 5 is a cross-sectional view of a rotor frame according to yet another example in the modification.

FIG. 6 is a cross-sectional view of a rotor frame according to still another example in the modification.

FIG. 7 is a perspective view of a rotor frame according to an example in a further modification.

FIG. 8 is an enlarged perspective view of a portion of a rotor frame according to another example in the further modification.

FIG. 9 is an enlarged perspective view of a portion of a rotor frame according to yet another example in the further modification.

FIG. 10 is a cross-sectional view of a rotor frame according to still another example in the further modification.

FIG. 11 is a cross-sectional view of a rotor frame according to still yet another example in the further modification.

### DETAILED DESCRIPTION

A motor according to the presently preferred embodiment will be hereinafter explained with reference to the drawings. It should be noted that in the following explanation, the term “axial direction” refers to an extending direction of a rotational axis O of the motor. On the other hand, the term “circumferential direction” refers to a circumferential direction of an imaginary circle about the rotational axis O, whereas the term “radial direction” refers to a radial direction of the imaginary circle about the rotational axis O. Furthermore, the term “first side in the axial direction” means a lower side, whereas the term “second side in the axial direction” means an upper side.

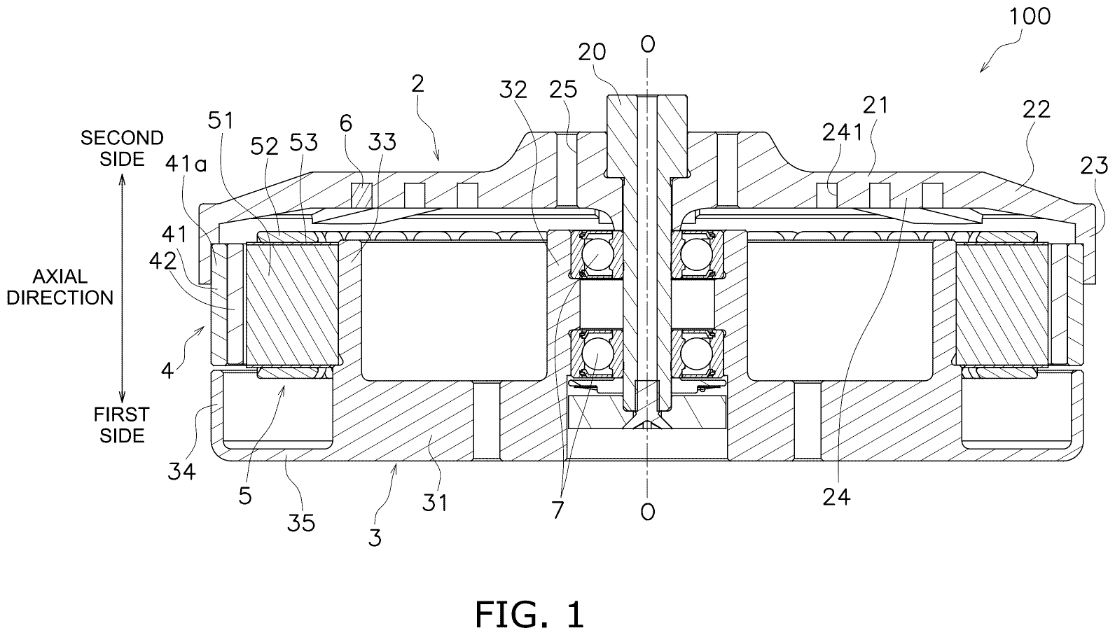

As shown in FIG. 1, a motor 100 includes a rotor frame 2, a stator frame 3, a rotor 4, a stator 5, and at least one balance weight 6. The motor 100 may, for example, be a drone motor. The motor 100, when described in detail, may be used for an industrial drone. In that application, the motor 100 is configured to rotate a propeller of the drone (omitted in the illustrations). The propeller is disposed on the second side of the motor 100 in the axial direction. The rotational axis O of the motor 100 extends in an up-and-down direction. In other words, the axial direction means the up-and-down direction in the presently preferred embodiment.

The drone would include a plurality of motors of the same type as the motor 100. In general, the drone might include four motors 100. The motors 100 are attached to a body part of the drone through arms and so forth, respectively. The body part of the drone accommodates a battery, a control unit, and so forth.

### Rotor Frame

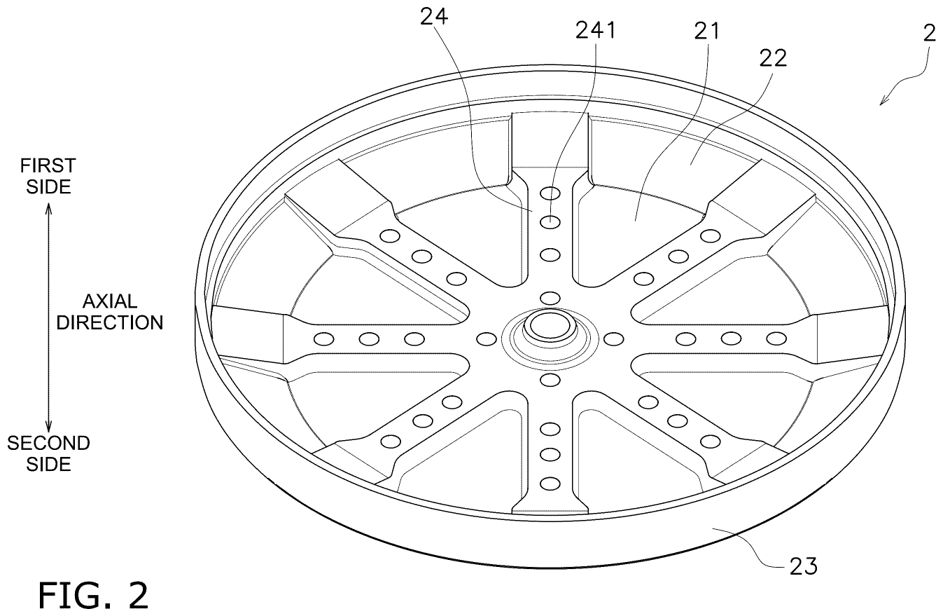

FIG. 2 is a perspective view of the rotor frame 2 as seen from the first side in the axial direction. As shown in FIGS. 1 and 2, the rotor frame 2 is configured to support the rotor 4. The rotor frame 2 is configured to be unitarily rotated with the rotor 4. Additionally, the rotor frame 2 is unitarily rotated with a shaft 20. It should be noted that the rotor frame 2 may be rotated relative to the shaft 20. The shaft 20 extends in the axial direction. The shaft 20 is disposed in a rotatable manner.

The propeller is fixed to the rotor frame 2 and is unitarily rotated with the rotor frame 2. For example, the rotor frame 2 includes a plurality of threaded holes 25 into which a plurality of bolts (omitted in the illustration) are screwed. The propeller is fastened to the rotor frame 2 by the bolts.

The rotor frame 2 includes a top plate portion 21, a slant portion 22, a first cylindrical portion, and a plurality of ribs 24. The rotor frame 2 preferably includes three or more ribs 24. It should be noted that in the presently preferred embodiment, the rotor frame 2 includes eight ribs 24.

The top plate portion 21 has a disc shape. The top plate portion 21 defines the upper surface of the motor 100. The slant portion 22 is disposed radially outside the top plate portion 21. The slant portion 22 is made in the shape of a circumferential annulus. The slant portion 22 is disposed to surround the top plate portion 21. The slant portion 22 axially slants toward the first side in the radially outward direction. In other words, the outside surface of the slant portion 22 faces the second side in the axial direction, while facing radially outward.

The first cylindrical portion 23 extends in the axial direction. When described in detail, the first cylindrical portion 23 extends from the radially outer peripheral edge of the slant portion 22 toward the first side in the axial direction. The first cylindrical portion 23 defines the outer peripheral surface of the rotor frame 2. The first cylindrical portion 23 extends circumferentially to connect the outer peripheral ends of the ribs 24.

The ribs 24 are provided on a surface, facing the first side in the axial direction, in the top plate portion 21. In other words, the ribs 24 are provided on the lower surface of the top plate portion 21. Each rib 24 extends in the radial direction. When described in detail, each rib 24 extends from the rotational axis O to the first cylindrical portion 23. In other words, each rib 24 extends radially not only on the top plate portion 21 but also along the slant portion 22.

The ribs 24 are disposed away from each other at intervals in the circumferential direction. In other words, the ribs 24 extend about the rotational axis O in a radial shape. It should be noted that the ribs 24 are coupled to each other at radially inner ends thereof.

The width of each rib 24 can be set to be, for instance, about 3.0 to 10.0 mm, albeit not particularly limited thereto. It should be noted that the term “width” of each rib 24 means the width of each rib 24 on the top plate portion 21. The thickness of each rib 24 is smaller than the width thereof. Here, the term “width” of each rib 24 means the dimension thereof in the circumferential direction, whereas the term “thickness” of each rib 24 means the dimension thereof in the axial direction.

Each rib 24 includes a plurality of accommodation holes 241. It should be noted that in the presently preferred embodiment, each rib 24 includes three accommodation holes 241. The accommodation holes 241 are disposed away from each other at intervals in the radial direction. In other words, the accommodation holes 241 are aligned along the extending direction of each rib 24. Each accommodation hole 241 opens toward the first side in the axial direction. It should be noted that the accommodation holes 241 do not penetrate the rotor frame 2 in the axial direction. In other words, none of the accommodation holes 241 is opened toward the second side in the axial direction.

The accommodation holes 241 are disposed radially inside the slant portion 22. In other words, although each rib 24 extends not only on the top plate portion 21 but also on the slant portion 22, the accommodation holes 241 are provided in a region, extending on the top plate portion 21, in each rib 24 without being provided in a region, extending on the slant portion 22, in each rib 24. In other words, as viewed in the axial direction, the accommodation holes 241 are disposed to overlap with the top plate portion 21 without being disposed to overlap with the slant portion 22. Each rib 24 is larger in width at the region thereof extending on the slant portion 22 than at the region thereof extending on the top plate portion 21.

As viewed in the axial direction, the accommodation holes 241 are disposed to overlap with a space between a second cylindrical portion 32 and a third cylindrical portion 33 of the stator frame 3.

The accommodation holes 241 are identical in opening area and depth to each other. The opening area of each accommodation hole 241 is set to be, for instance, about 0.79 to 50.26 mm², albeit not particularly limited thereto. On the other hand, the depth of each accommodation hole 241 is set to be about 1.0 to 5.0 mm.

### Balance Weight

At least one balance weight 6 is disposed in at least one of multiple accommodation holes 241. Each balance weight 6 may be made of metal or resin. For example, each balance weight 6 has a columnar shape and is inserted into a corresponding one of the accommodation holes 241. It should be noted that each balance weight 6 may be inserted into and adhered by an adhesive to the corresponding accommodation hole 241. Alternatively, each balance weight 6 may be made of resin paste poured into the corresponding accommodation hole 241.

Each balance weight 6 is completely accommodated in the corresponding accommodation hole 241. It should be noted that each balance weight 6 may protrude in part from the corresponding accommodation hole 241.

### Stator Frame

As shown in FIG. 1, the stator frame 3 is configured to support the stator 5. The stator frame 3 is disposed in a non-rotatable manner. The stator frame 3 supports the shaft 20 through a plurality of bearing members 7 such that the shaft 20 is rotatable relative to the stator frame.

The stator frame 3 includes a first coupling portion 31, the second cylindrical portion 32, the third cylindrical portion 33, a fourth cylindrical portion 34, and a second coupling portion 35.

The second cylindrical portion 32 extends in the axial direction. The bearing members 7 are attached to the interior of the second cylindrical portion 32. Additionally, the shaft 20 extends in the interior of the second cylindrical portion 32.

The third cylindrical portion 33 extends in the axial direction. The third cylindrical portion 33 is disposed radially outside the second cylindrical portion 32. The third cylindrical portion 33 is disposed to encircle the second cylindrical portion 32. The third cylindrical portion 33 is disposed radially outside of the second cylindrical portion 32 at an interval.

The first coupling portion 31 couples the second and third cylindrical portions 32 and 33 to each other. The first coupling portion 31 is not particularly limited in shape. For example, the first coupling portion 31 may take the form of an annular plate including a plurality of openings or alternatively may take the form of a plurality of radially extending arms.

The fourth cylindrical portion 34 extends in the axial direction. The fourth cylindrical portion 34 is disposed radially outside the third cylindrical portion 33. The fourth cylindrical portion 34 is disposed to encircle the third cylindrical portion 33. The fourth cylindrical portion 34 is disposed radially outside of the third cylindrical portion 33 at an interval. The fourth cylindrical portion 34 is smaller in axial length than the third cylindrical portion 33.

The second coupling portion 35 couples the third and fourth cylindrical portions 33 and 34 to each other. The second coupling portion 35 is not particularly limited in shape. For example, the second coupling portion 35 may take the form of an annular plate including a plurality of openings or alternatively may take the form of a plurality of radially extending arms.

### Rotor

The rotor 4 is supported by the rotor frame 2. When described in detail, the rotor 4 is supported by the first cylindrical portion 23 of the rotor frame 2. The rotor 4 is unitarily rotated with the rotor frame 2. The rotor 4 has an annular shape. The rotor 4 includes a yoke 41 and a plurality of permanent magnets 42.

The yoke 41 has a cylindrical shape. The yoke 41 is fixed to the rotor frame 2. When described in detail, the yoke 41 is attached to the first cylindrical portion 23 of the rotor frame 2. It should be noted that the outer peripheral surface of the yoke 41 is fixed to the inner peripheral surface of the first cylindrical portion 23.

The yoke 41 is attached at an end 41a thereof, which is an end disposed on the second side in the axial direction, to the first cylindrical portion 23. The yoke 41 protrudes from the first cylindrical portion 23 toward the first side in the axial direction. In other words, excluding the end 41a, the remaining part of the yoke 41 is exposed radially outward. In cooperation with the rotor frame 2 and the stator frame 3, the yoke 41 forms an outer shell of the motor 100.

The permanent magnets 42 are attached to the inner peripheral surface of the yoke 41. The permanent magnets 42 are disposed away from each other at intervals in the circumferential direction. The permanent magnets 42 are disposed radially outside the stator 5. In other words, the permanent magnets 42 are disposed to enclose the stator 5. It should be noted that each permanent magnet 42 is disposed radially away from the stator 5 at an interval.

### Stator

The stator 5 has an annular shape. The stator 5 is disposed radially inside the rotor 4. The stator 5 is disposed in a non-rotatable manner relative to the stator frame 3. The stator 5 is supported by the stator frame 3. The stator 5 is disposed radially outside the third cylindrical portion 33 of the stator frame 3. In other words, the stator 5 is disposed to encircle the third cylindrical portion 33. The stator 5 is supported by the third cylindrical portion 33.

The stator 5 includes a stator core 51 and a plurality of coil portions 52. The stator core 51 is formed by laminating a plurality of electromagnetic steel plates as a plurality of layers.

The coil portions 52 are wound about the stator core 51. When described in detail, the coil portions 52 are wound about teeth of the stator core 51. It should be noted that an insulating layer 53 is interposed between the coil portions 52 and the stator core 51.

### Modifications

One preferred embodiment of the claimed invention has been described above. However, the claimed invention is not limited to the above, and a variety of changes can be made without departing from the scope and spirit of the claimed invention. It should be noted that, basically speaking, respective modifications to be described are applicable simultaneously.

(a) In the preferred embodiment described above, the accommodation holes 241 are identical in opening area and depth to each other; however, the rotor frame 2 is not limited in configuration to this. Specifically, the accommodation holes 241 may be different in opening area from each other.

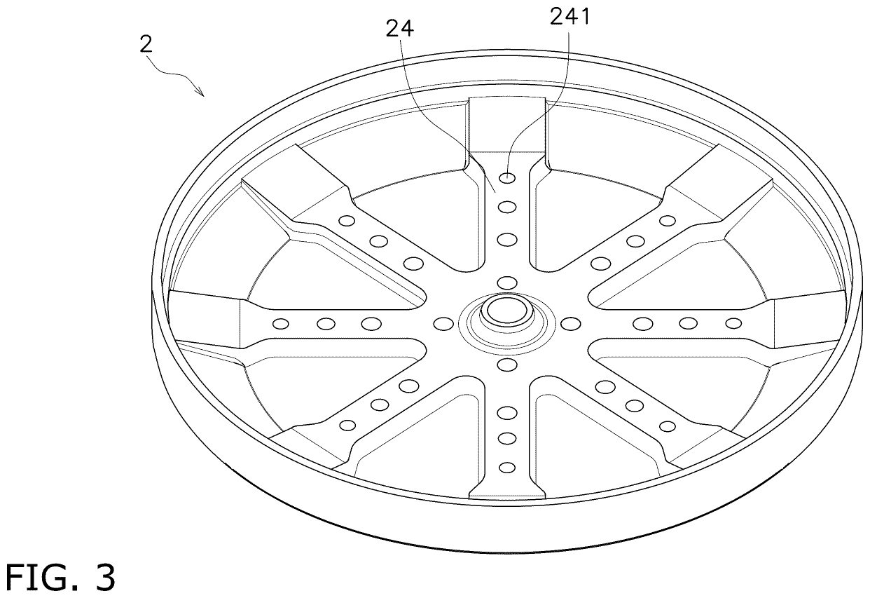

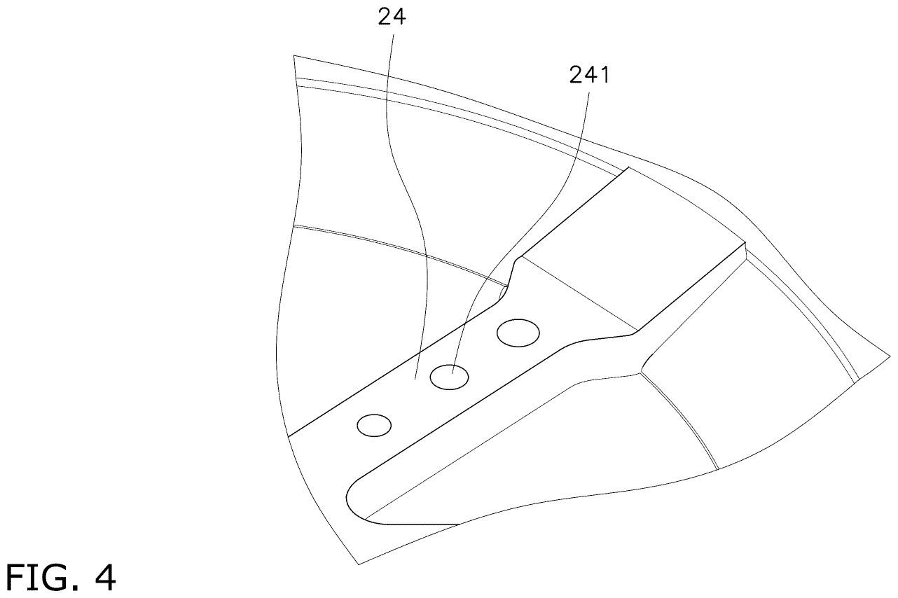

For example, as shown in FIG. 3, the multiple accommodation holes 241 provided in each rib 24 may be aligned radially outward in a descending order of opening area. Alternatively, as shown in FIG. 4, the multiple accommodation holes 241 provided in each rib 24 may be aligned radially outward in an ascending order of opening area.

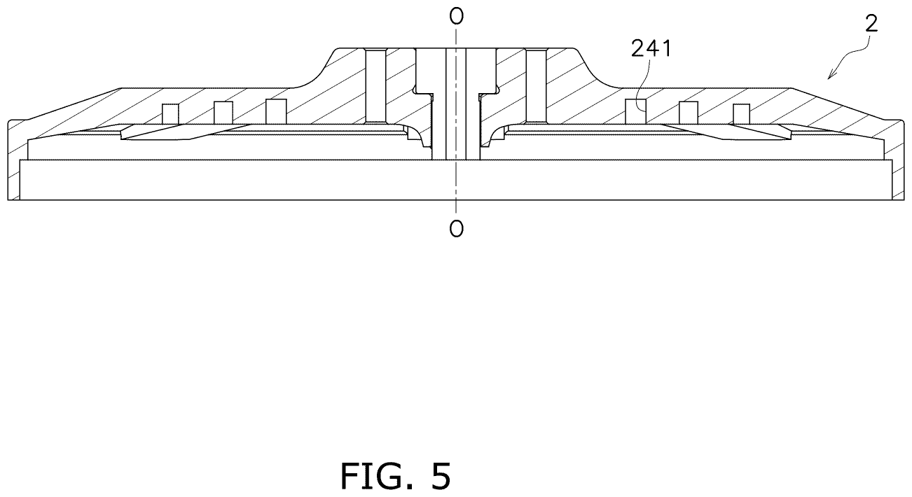

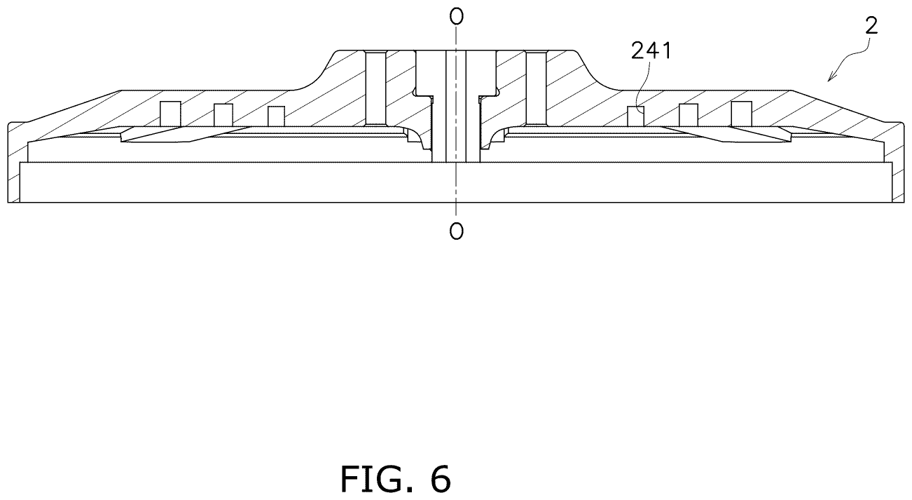

On the other hand, the accommodation holes 241 may be different in depth from each other. For example, as shown in FIG. 5, the multiple accommodation holes 241 provided in each rib 24 may be aligned radially outward in a descending order of depth. Alternatively, as shown in FIG. 6, the multiple accommodation holes 241 provided in each rib 24 may be aligned radially outward in an ascending order of depth.

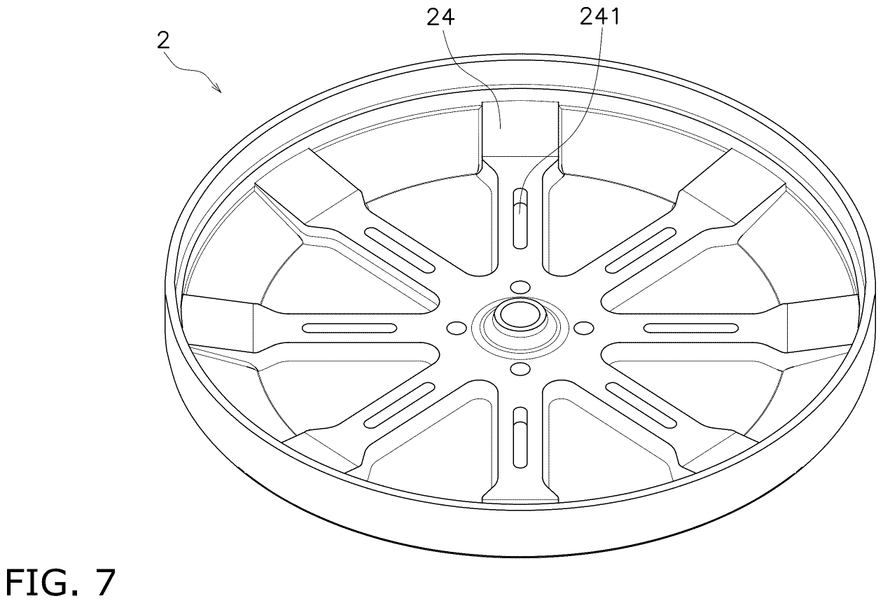

(b) In the preferred embodiment described above, each accommodation hole 241 has a circular shape as seen in the axial direction; however, each accommodation hole 241 is not limited in shape to this. For example, as shown in FIG. 7, each accommodation hole 241 may be a slot-shaped hole extending in the radial direction. Each accommodation hole 241 is constant in width along the radial direction. Here, the term “width” of each accommodation hole 241 means the dimension thereof in the circumferential direction.

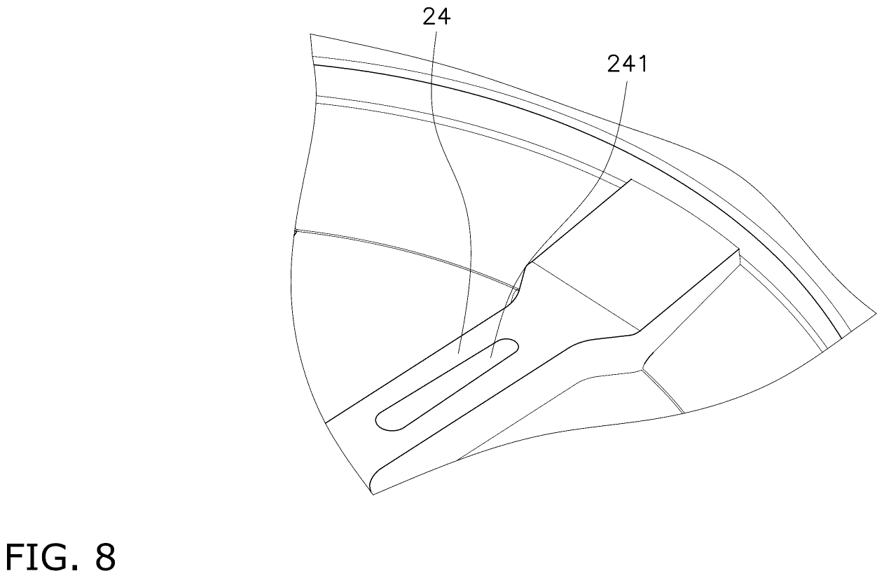

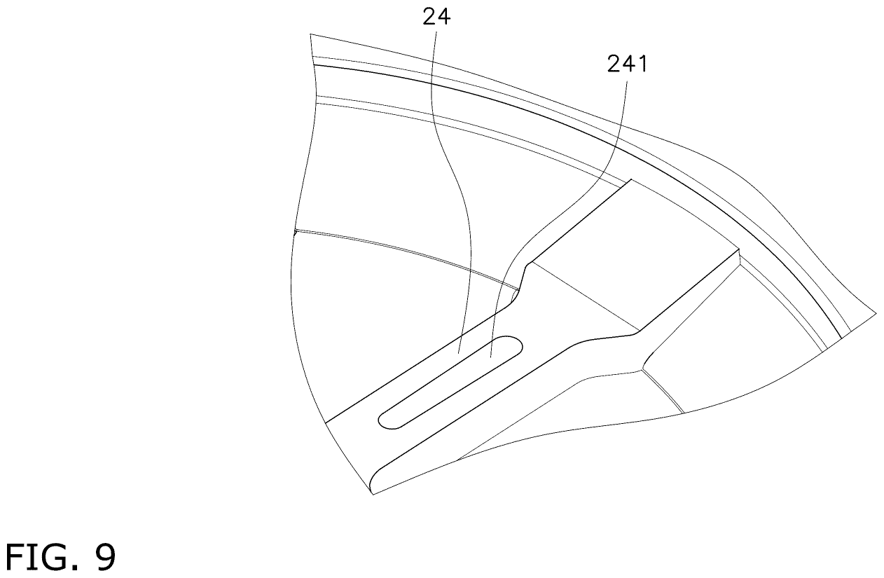

It should be noted that as shown in FIG. 8, each accommodation hole 241 may be gradually reduced in width radially outward. Alternatively, as shown in FIG. 9, each accommodation hole 241 may be gradually increased in width radially outward.

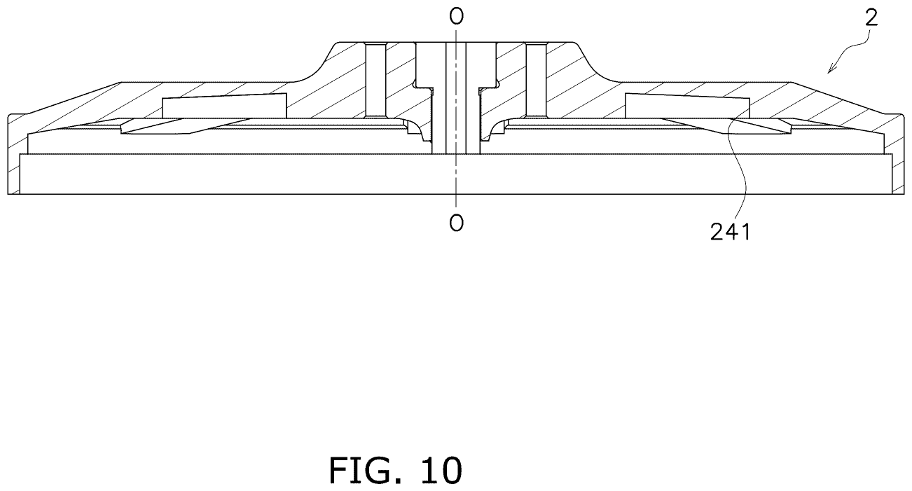

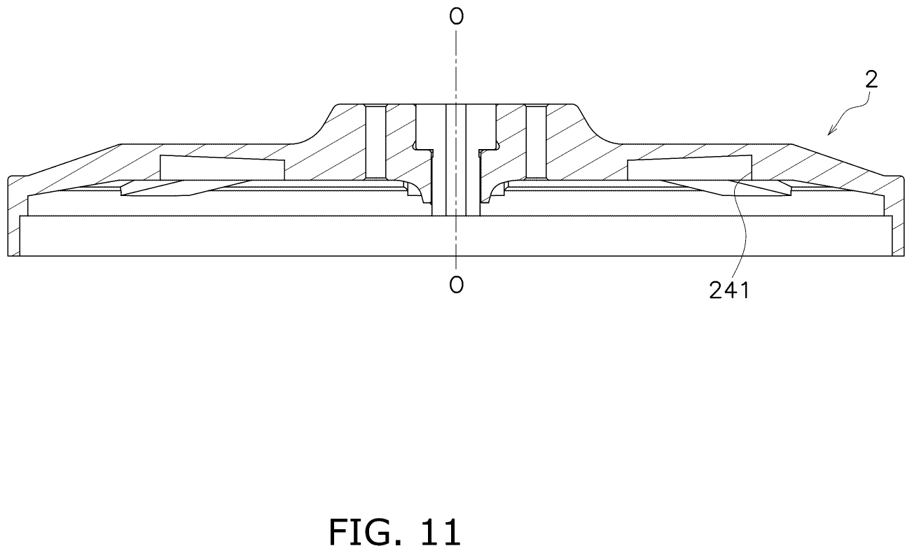

On the other hand, each accommodation hole 241 may be constant or variable in depth along the radial direction. For example, as shown in FIG. 10, each accommodation hole 241 may be gradually reduced in depth radially outward. Alternatively, as shown in FIG. 11, each accommodation hole 241 may be gradually increased in depth radially outward.

(c) In the preferred embodiment described above, the rotor frame includes the first cylindrical portion by which the rotor is supported. However, the rotor is not limited in configuration to this. For example, the rotor may be supported by the ribs.

(d) In the preferred embodiment described above, the motor 100 includes at least one balance weight 6; however, the motor 100 may not include any balance weight 6. For example, when of a type not requiring balance adjustment, the motor 100 would not include any balance weight 6.

### LIST OF REFERENCE NUMERALS

2: Rotor frame, 22: Slant portion, 24: Rib, 241: Accommodation hole, 4: Rotor, 5: Stator, 6: Balance weight, 100: Motor

1. A motor, comprising:
a rotor frame including a plurality of ribs, the plurality of ribs each including at least one accommodation hole, the plurality of ribs disposed away from each other at intervals in a circumferential direction, the plurality of ribs each extending in a radial direction;
a rotor supported by the rotor frame, the rotor having an annular shape; and
a stator disposed radially inside the rotor.

2. The motor according to claim 1, further comprising at least one balance weight disposed in at least one of the accommodation holes.

3. The motor according to claim 1, wherein each of the ribs includes multiple accommodation holes disposed away from each other at intervals in the radial direction.

4. The motor according to claim 3, wherein the accommodation holes in a given rib are different in opening area from each other.

5. The motor according to claim 3, wherein the accommodation holes in a given rib are aligned radially outwardly in a descending order of opening area.

6. The motor according to claim 3, wherein the accommodation holes in a given rib are aligned radially outwardly in an ascending order of opening area.

7. The motor according to claim 3, wherein the accommodation holes in a given rib are different in depth from each other.

8. The motor according to claim 3, wherein the accommodation holes in a given rib are aligned radially outwardly in a descending order of depth.

9. The motor according to claim 3, wherein the accommodation holes in a given rib are aligned radially outwardly in an ascending order of depth.

10. The motor according to claim 1, wherein each of the accommodation holes is made in the shape of a slot-shaped hole extending in the radial direction.

11. The motor according to claim 10, wherein each of the slot-shaped accommodation holes is gradually reduced in width as it extends radially outwardly.

12. The motor according to claim 10, wherein each of the slot-shaped accommodation holes is gradually increased in width as it extends radially outwardly.

13. The motor according to claim 10, wherein each of the accommodation holes is gradually reduced in depth radially outwardly.

14. The motor according to claim 10, wherein each of the accommodation holes is gradually increased in depth radially outwardly.

15. The motor according to claim 1, wherein
the rotor frame includes a top plate portion and a slant portion, the top plate portion having a disc shape, the slant portion disposed radially outside the top plate portion, the slant portion having an annular shape, and
the accommodation holes are disposed in the ribs radially inside of the slant portion.
